(19) United States
(12) Patent Application Publication
(10) Pub. No.: US 2009/0138345 A1
(43) Pub. Date: May 28, 2009

(54) TIME MONITORING SYSTEM

(75) Inventors: Christopher James Dawson, Arlington, VA (US); Vincenzo Valentino Di Luoffo, Sandy Hook, CT (US); Craig William Fellenstein, Brookfield, CT (US); Rick Allen Hamilton, II, Charlottesville, VA (US)

Correspondence Address: HAMRE, SCHUMANN, MUELLER & LARSON, P.C, P.O. BOX 2902, MINNEAPOLIS, MN, 55402-0902, US

(73) Assignee: International Business Machines Corporation, Armonk, NY (US)

(21) Appl. No.: 12/364,741

(22) Filed: Feb. 3, 2009

Related U.S. Application Data
(62) Division of application No. 11/423,199, filed on Jun. 9, 2006.

(51) Int. Cl. G06Q 30/00; G08G 1/14; G06Q 50/00

(52) U.S. Cl. 705/13; 340/932.2; 705/418

(57) ABSTRACT

A system, a method, and a service that monitors the time a space is occupied. The time period for occupation of the space may be prepaid or the fees may accumulate while the space is occupied. The system detects when an occupant enters the space and starts a timer. The system further provides a user interface whereby a user may prepay for an allotted period of time or may accumulate time in the space and then be billed later. Identifying information about the occupant may be acquired by an imaging device. The imaging device may further poll the space to determine if and when the occupant departs from the space. Identifying information may also be acquired through a user interface in which a user may enter identifying information, such as a credit card, a license number, a VIN, a driver's license, etc. The fact that the space has been occupied, the identifying information, and any prepaid amounts are transmitted via a communication device to a control station. The control station may monitor events in the space such that when an occupant departs the space, the timer is reset. Alternatively, the control station may issue fees for use of the space, may issue penalties or even call for removal of the occupant from the space if occupation of the space exceeds the amount of time purchased or poses an abuse of the privilege of using the space.

### PRIORITY INFORMATION

This application is a Divisional Application of U.S. application Ser. No. 11/423,199 filed Jun. 9, 2006 and entitled TIME MONITORING SYSTEM, which is hereby incorporated by reference in its entirety.

### FIELD OF THE INVENTION

This invention relates generally to the field of monitoring timed events in a particular space and when an authorized time for occupation of the space expires, the event is automatically reported. Persons or entities responsible for the space can be notified and appropriate action can be taken.

### BACKGROUND OF THE INVENTION

In most cities in the United States, it is common practice to pay for parking motorized vehicles in public and private parking spaces and parking lots for a specified time period. Paying for the parking space is usually accomplished by feeding coins into a slot of a parking meter where there is not a parking attendant. It is a well know fact, moreover, that people park their vehicles for random periods of time because people may leave before the time paid on the meter expires; another person may drive into the space thereby taking advantage of the unexpired time on the meter. More often, however, people either intentionally or inadvertently overextend their allotted time and do not return when the meter expires to “feed the meter.” In the current art, verification that a vehicle has been parked in a space for longer than the authorized time is a manual process undertaken by a meter maid or other administrative law enforcement personnel.

Traffic wardens, meter maids, or other officers are often unable to monitor these metered spaces at these random intervals because hiring many people to check each parking space is inefficient and not cost-effective. In larger cities, there are traffic wardens that check metered parking spaces frequently but, currently, there are no automated methods that continually or on a polled basis monitor when the purchased time for a parking space has been overextended or when a new vehicle has entered a space, and it may be advantageous to fine vehicles, or call tow trucks when necessary. Thus, manual monitoring of parking spaces is inefficient and costly, both in terms of the human effort required and the low “hit” rate of discovering vehicles which have exceeded their authorized time. Accordingly, there exists a need in the art to overcome the deficiencies and limitations described hereinabove.

### SUMMARY OF THE INVENTION

These needs and other advantages that will become apparent are solved by an arrangement and a method and a service whereby a space monitoring system may be modified with a communication device and an imaging device. In an alternative embodiment, the space monitoring system has integrated the time monitoring aspects of the invention. For instance, if the space monitoring system that is modified to become the time monitoring system of the invention is a parking meter, the imaging device may obtain unique identifying information of a vehicle from a license plate, a vehicle identification number, an ONSTAR system, a credit or debit card, etc. As long as the occupant is authorized to occupy the space, which is monitored on a continuous or a polled basis, no action is taken. The time monitoring system of the invention, however, detects when the authorized time for occupation of the space has expired; pattern matching is undertaken to ensure whether the occupant is the same occupant who initialized a timer or is a different occupant. The identifying and time information then is wirelessly sent using known WiFi, WiMax, cellular or regular telephone technologies to a control station. At this point, the control station or a service provider may process an appropriate fee or penalty. Optionally, the occupant may be removed.

### BRIEF DESCRIPTION OF THE DRAWINGS

FIG. 1 is a simplified block diagram of the components of a system that can monitor timed events in a particular space in accordance with an embodiment of the invention.

FIG. 2 is a simplified block of the components of FIG. 1 as they may be integrated into a circuit.

FIG. 3 is a simplified flow chart of the process by which the system that monitors timed events functions. It is suggested that FIG. 3 be printed on the face of the patent.

### DETAILED DESCRIPTION OF THE INVENTION

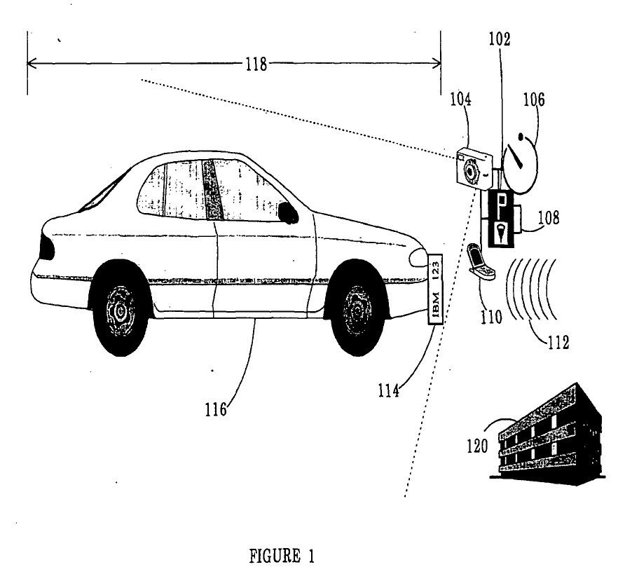

One embodiment of a time monitor system 100 is shown in FIG. 1 as having a space monitoring system 102, such as a parking meter, modified to be electronically connected to an imaging device 104 and a communication device 110. Alternatively the space monitoring system 102, such as the parking meter, may be manufactured having an imaging device 104 and a communication device 110, each of which may be generic field replaceable units (FRUs). The imaging device 104, preferably a digital camera, may be mounted on or adjacent to the parking meter 102 or integrated with the post of the space monitoring system, hereinafter referred to as a parking meter 102 so that the imaging device 104 has full view of the parking space 118 and is positioned so that it can read identification information 114 about the vehicle 116 parked in a parking space 118. Identification information 114 may be the license plate or a vehicle identification number (VIN). Parking meter 102 has a countdown timer 106, which can be connected to the imaging device 104 and a logic control or processor 108, also attached to or integrated with the parking meter 102.

In one embodiment, the imaging device 104 is capable of taking images or pictures of the parking space 118 on a polled basis, e.g., perhaps once per minute or more or less frequently depending upon the application, to determine whether a vehicle 116 has entered or departed from the space 118. When a vehicle 116 parks in the space 118, the parking meter 102 perhaps incorporating a motion sensor detects that the vehicle 116 has entered the space 118. The imaging device 104 may use pattern matching against the outline of the vehicle 116 itself. Optionally, the processing logic 108 within the meter 102 may detect that a vehicle 116 has entered the space 118 by pattern matching against the license plate or other identifying information 114. It is suggested that a pattern matching field of view for the imaging device 104 focus on a section of pavement or other such static space for detection of the vehicle 116. In other words, if the imaging device 104 is a horizontally focused camera 104 at license plate level, then the time monitor system 100 could be subject to high false positives because vehicles in adjacent spaces may actually be within the field of view. Either a single imaging device 104 pointing slightly downward at the license plate; or dual imaging devices 104, one on a static “reference” spot and one aligned so that its field of view could capture the identifying information 114 about the vehicle may be implemented.

Each parking meter 102 is able to make a data connection over a communication channel 112 to which the communication device 110 is connected, such as, but not limited to a regular cellular phone network, or using WiFi/WiMax principles. The communication device 110 is capable of receiving and sending either digital or analog information to a control station 120. Control station 120 is equipped with an appropriate receiver and processing to receive and process the data communicated.

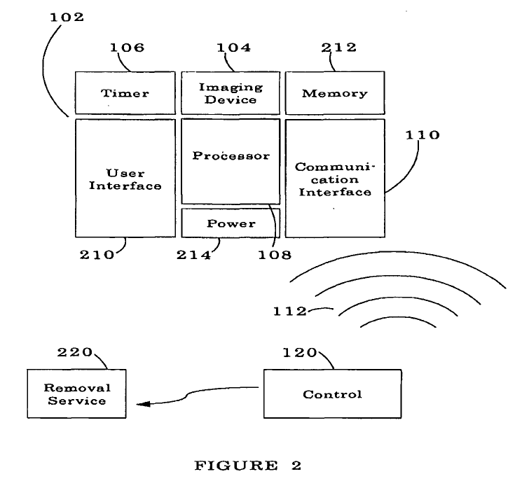

FIG. 2 is a simplified block diagram of another embodiment of an integrated time monitor system 200 in which the timer 106, the imaging device 104, the processing logic or processor 108, and the communication interface 110 are integrated with a user interface 210, a digital memory 212, and a power source 214 which can be manufactured with the time and space monitoring system. Alternatively, the integrated system 200 may be physical and electronically connected as an after-market modification. The communication interface 110 may include a cellular telephone or other communication technology as described above. The digital memory 212 may be erasable and/or refreshable. User interface 210 may be as simple as a slot and a rotating knob and an analog timer showing the amount of time purchased, or may be as complex as a computerized user interface having a keyboard or touch pad and a screen which interacts with the user to request identifying information, payment information, and may allow for periods of time to be prepurchased on a credit or debit card, or billed otherwise. Still yet, any of the components of either embodiment of FIG. 1 or FIG. 2 could be deployed, managed, serviced by a service provider who offers to monitor occupation of paid spaces on a continuous or polled basis using pattern recognition or matching, and then provide automatic billing or fine assessment depending upon the time the space was occupied by the same occupant. The integrated time-monitoring system 200 operates on the same basic principles as described below.

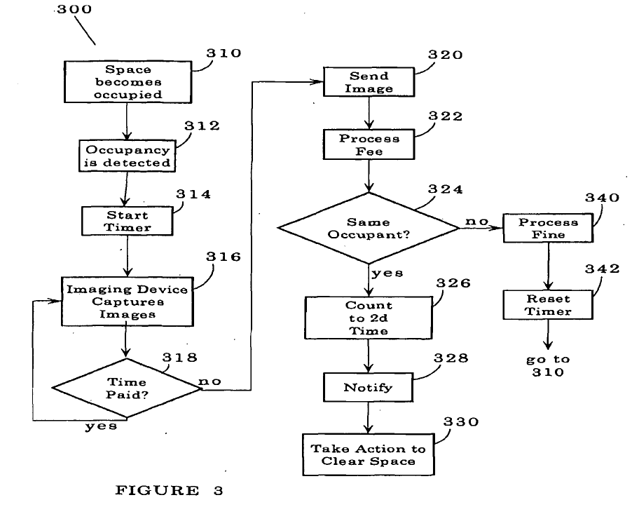

FIG. 3 is a simplified block diagram a method 300 by which either time monitor system of FIG. 1 and FIG. 2 can monitor events in a space and when the events exceed their allotted time, take administrative and/or remedial action. In step 310 an occupant enters a particular space, such as a vehicle entering a parking space, or a person entering a hotel room. In step 312, the time monitor system detects the occupant in the space. This detection can occur by the imaging device capturing images, such as a camera taking pictures, on a polled basis; or the detection may occur when a motion sensor detects sufficient motion within the space; or alternatively, when money or other form of payment is inserted into the meter. Typically, coins may be deposited into a slot in the parking meter. It is further envisioned, moreover, that payment may be made by credit cards, debit cards, or even microprocessing cards. In any event, whatever method is used to detect that a vehicle has entered the parking space, the timer is started in step 314. The timer 314 may be a countdown timer as is known in the art; alternatively, the timer 314 may be a count up timer. Upon initiation of the timer, the imaging device captures an image of the vehicle and its identifying information for pattern matching as discussed above. In addition, the patterns for pattern matching may be obtained independent of the VIN or the license plate. The image preferably is continually or on a polled basis captured and time-stamped.

In step 318, the time monitor system inquires if the timer is still running, i.e., if the meter still has paid time. If so, then the system continues to monitor the space and continue to match the patterns and capture and time-stamp images as in step 316 images. The time monitor system continues to transmit information while the occupant remains in the space. If, however, the timer has expired, then in step 320, pattern matching indicates that the same occupant has exceeded the time and the picture and the time are sent over the communication device to a control station. In one embodiment, the time monitor system may calculate the appropriate fees and transmit this information to the control station in step 320. Alternatively, the control station may process the appropriate fees in step 322. The time monitor system then continually or on a polled basis monitors the space and matches patterns or identifying information to determine if the same occupant is in the space at step 324. Once the occupant has departed, the amount of the payment owed for a time or beyond the paid-for time is calculated in step 340, the identifying information is resolved and an invoice or parking ticket is issued. The timer is cleared, as in step 342. If the occupant is not the same as the first occupant as determined by pattern matching, then it is presumed that the first occupant departed from the space so again the appropriate fees can be updated for the first occupant, the timer can be cleared in step 342, and the process goes to step 310.

If the occupant is the same occupant as that which initiated the timer in step 324, the fees may be continually updated and processed until, at step 326, a predetermined or second time is reached. This predetermined or second time may represent that time considered excessive at which it becomes necessary to take action, such as to remove the occupant from the space, tow an overparked vehicle or to place a wheel lock on a vehicle. What time is excessive actually depends upon the circumstances; for instance, excessive time may be 24 hours on a public street; excessive time may be one or two months at an airport parking lot. Even, in a busy place, ten or fifteen minutes may be considered excessive if the space is occupied five minutes typically. If the time has been prepaid, an excessive time may represent an additional amount of time equal to the time purchased. Thus, at step 328 the time monitor system notifies the control station that the occupant has used the space for a prolonged and perhaps excessive amount of time. The control station then, at step 330, may transmit the picture or other identifying information to the service provider to remove the occupant from the space.

In another embodiment, the invention provides a business method that performs the process steps described above on a subscription and/or fee basis; that is, a service provider could offer to monitor the occupancy of paid spaces on a polled or continuous basis using pattern matching and when the occupancy ceases or becomes excessive, the service provider may render an appropriate fee or penalty. In this case, the service provider can create, maintain, support, etc., a computer and communications infrastructure that performs the process steps of the invention for one or more customers. In return, the service provider can receive payment from its customer(s) under a subscription contract and/or a fee agreement.

Many variations are envisioned and are intended to be covered within the scope of the claims. For example, the identification information and/or pattern to be matched may be the vehicle's license plate, the VIN, or an identifier associated with the vehicle's microprocessor, or an ONSTAR identification number, or an individualized global positioning system (GPS) integrated within the vehicle. In the event that the vehicle has an ONSTAR or other integrated GPS system with communication functions, then the processing system on the vehicle may communicate directly with the integrated parking meter/communications interface of the integrated time monitor system. As discussed briefly, payment may be deposited into a slot with coins. Alternatively, the user interface of FIG. 2 may allow for alternative payment methods, such as credit or debit cards. If the space is a parking space, the parking fees may even be automatically charged to the vehicle's ONSTAR or other GPS or on-vehicle processing system. As mentioned briefly, the imaging device may be a digital or an infrared camera or other imaging device. The imaging device may incorporate a motion sensor in order to detect whether an occupant enters or departs from the space.

Using the time monitor system described herein for parking spaces, a one-hundred percent enforcement rate for parking violations is theoretically possible. Given the budgetary dearth of municipalities, cities may increase revenues by conducting more efficient enforcement operations. The time monitor system offers further advantages. By automating the process of monitoring parking spaces, the need for traffic wardens is eliminated, thus saving money. The number of tickets issued for vehicles that are illegally parked will be greatly increased. Companies that provide towing or wheel lock services can be automatically notified if and when a vehicle needs to be towed or locked. These remediating companies will automatically receive a picture of the vehicle including license plate making removal of the vehicle more efficient. Further, the time monitor system continually monitors the parking space and automatically resets the parking meter when the vehicle leaves the parking space.

It will be appreciated that variations of some elements are possible to adapt the invention for specific conditions or functions. While described herein as a parking meter system, the concepts of the present invention can be further extended to a variety of other applications that are clearly within the scope of this invention, such as renting hotel rooms, capsule hotels in Japan, or personal lockers in airports or other public spaces, or showers; the advantage being that no person, such as a desk clerk or parking attendant, is required to use and occupy the space. Having thus described the present invention with respect to preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

What is claimed is:

1. A time monitor system for a space, the system comprising:
a timer that is initiated when a space becomes occupied;
an imaging device that captures images at a frequent interval to detect if the space becomes occupied by an occupant;
a communication device;
a user interface;
processing logic including pattern recognition logic to determine if the occupant is the same occupant as when the timer was initiated, wherein the timer, the imaging device, the communication device, the user interface, and processing logic are electronically connected and mounted so that the imaging device may capture images of the space; and
a control station to receive one-way communications from the communication device about the status of the space.

2. The time monitor system of claim 1 further comprising a power source and a semiconductor memory, wherein the power source and the semiconductor memory, the timer, the imaging device, the communication device, the user interface, and the processing logic are integrated into a single unit.

3. The time monitor system of claim 1 wherein the timer is a countdown timer.

4. The time monitor system of claim 1 wherein the timer is count up timer.

5. The time monitor system of claim 1 wherein the imaging device is a digital camera.

6. The time monitor system of claim 1 further comprising a motion sensor connected to the processing logic and the timer.

7. The time monitor system of claim 1 wherein the user interface is a slot for the deposit of money which can be identified by the processing logic which presets the timer for a first period of time.

8. The time monitor system of claim 1 wherein the communication device is a cellular phone preprogrammed for automatic communication to the control station.

9. A one-way communications method of monitoring a space and determining payment for occupation of the space comprising the steps of:
detecting that the space has become occupied;
starting a timer;
obtaining identifying information of the occupant and time-stamping the identifying information with the initial time of occupation;
transmitting the initial time-stamped identifying information to a control station;
monitoring the space to determine if the space remains occupied by the same occupant and updating the time-stamped identifying information;
if occupant leaves the space, transmitting the departure time-stamped identifying information to a control station;
resetting the timer;
determining if a fee will be charged based on the duration of time from the initial time-stamped identifying information to the departure time-stamped identifying information; and
if occupant remains in the space, transmitting the updated time-stamped identifying information and determining that the occupant will be penalized for extended occupation of the space.

10. The method of claim 9, further comprising:
transmitting the identifying information and a location of the space to a service company;
requesting that the service company remove the occupant from the space.

11. The method of claim 9, further comprising:
transmitting the identifying information and a location of the space to a service company;
requesting that the service company prevent the occupant from leaving the space until a fee has been paid.

12. A method to monitor the time in which a space is occupied by an occupant, comprising the steps of:
detecting that the space has become occupied;
starting a timer;
obtaining identifying information about the occupant;
transmitting the identifying information to a control station;
determining if the occupant still occupies the space;
updating and processing a fee for the time the occupant has occupied the space.

13. The method of claim 12, further comprising:
determining if the occupant has prepaid for an amount of time to occupy the space;
determining if the space is still occupied by the occupant beyond the prepaid amount of time;
determining if the occupant still occupies the space beyond the prepaid amount of time;
updating and processing a fee for the time the occupant occupies the space.

14. The method of claim 12, further comprising:
determining that the space is still occupied by the occupant beyond the prepaid amount of time;
determining that the amount of time in which the occupant has occupied the space warrants evacuation;
determining that the space should be cleared of the occupant;
forwarding the identifying information to a service company to remove the occupant.

15. The method of claim 12, further comprising:
determining that the space is still occupied by the occupant beyond the prepaid amount of time;
determining that the amount of time in which the occupant has occupied the space is excessive;
forwarding the identifying information to a service company to lock the wheels of the vehicle.

16. A method for deploying a computing and a communication infrastructure, comprising:
attaching an imaging device, a processing device, and a communications device onto a space occupation system, wherein the imaging device, the processing device, and the communications device in combination with the space occupation system is capable of performing a process for the purpose of monitoring the occupation of the space, the process further comprising:
detecting occupation of a space;
obtaining identifying information of an occupant occupying the space;
starting a timer;
monitoring the occupation of the space by the occupant on a polled basis by pattern matching of the identifying information obtained from the imaging device;
determining that the occupant is no longer authorized to occupy the space;
communicating that the occupant is no longer authorized to occupy the space;
determining an appropriate penalty for the unauthorized occupation;
automatically assessing the appropriate penalty to the occupant.
